(19) United States
(12) Patent Application Publication
(10) Pub. No.: US 2006/0187963 A1
(43) Pub. Date: Aug. 24, 2006

(54) Method for sharing single data buffer by several packets

(75) Inventors: Claude Basso, Raleigh, NC (US); Jean L. Calvignac, Raleigh, NC (US); Chih-jen Chang, Apex, NC (US); Fabrice J. Verplanken, La Gaude (FR)

Correspondence Address: DRIGGS, HOGG & FRY CO. L.P.A., 38500 CHARDON ROAD, DEPT. IRA, WILLOUGBY HILLS, OH, 44094, US

(73) Assignee: International Business Machines Corporation, Armonk, NY (US)

(21) Appl. No.: 11/062,036

(22) Filed: Feb. 18, 2005

(51) Int. Cl. H04J 3/24

(52) U.S. Cl. 370/474; 370/412

(57) ABSTRACT

Methods, computer readable programs and network processor systems appropriate for IP fragmentation and reassembly on network processors comprising a plurality of buffers and buffer control blocks, the buffer control blocks comprising a buffer usage field, the buffer usage field having a value set responsive to a quantity of frame data fragments, wherein the network processor system associates a buffer control block with each buffer and frees a first buffer after reading a frame data fragment responsive to the first buffer control block buffer usage field value indicating only one frame data fragment is present in the first buffer.

### CROSS-REFERENCE TO RELATED APPLICATION

The invention disclosed in this application is related in subject matter to co-pending U.S. patent application Ser. No. __,______ (RPS920040036) filed ______ by ______ et al for “Apparatus and Method for Efficiently Modifying Network Data Frames,” and assigned to a common assignee with this application, the disclosure of which is incorporated herein by reference.

The invention disclosed in this application is also related in subject matter to co-pending U.S. patent application Ser. No. 09/839,010, filed Apr. 20, 2001 by C. Basso et al for “Data Structures for Efficient Processing of IP Fragmentation and Reassembly” and assigned to a common assignee with this application, the disclosure of which is incorporated herein by reference.

### FIELD OF THE INVENTION

The present invention generally relates to communications on a network by a network processor and, more particularly, to a method of performing Internet Protocol (IP) fragmentation and reassembly in a network processor in a more efficient manner than current designs accomplish this process.

### BACKGROUND OF THE INVENTION

In telecommunications scenarios, it is sometimes necessary to break a data frame into smaller pieces prior to transmission. This is typically done in cases where a frame may be too large for a physical link (i.e., Ethernet Max transfer unit=1.5 k bytes, token ring=17 k bytes). For such a scenario, the frame must be divided into smaller frame segments in order to satisfy link requirements. In particular, Internet Protocol (IP) fragmentation involves splitting an IP frame into smaller pieces. A typical solution in a network processor involves copying the data to create the body of each fragment, creating a new header for the fragment, and updating the buffer linked list. This is done for each IP fragment to be generated. Copying the data comprising the body of each fragment can impose a significant burden on memory allocation requirements. High performance network processors generally cannot afford to allocate the additional memory bandwidth required in this approach. In a high performance network processor, one must develop a novel solution in order to minimize memory requirements for IP fragmentation (and IP reassembly).

It is known that frame manipulation can lead to split frame data within one data buffer (e.g. IP Fragmentation). Prior art implementations rely on data copy methods to split two data parts into two distinct data buffers. However, these “data copy” methods result in diminished system resources and performance to support high data rates because of the additional memory bandwidths required for the data copy “read +write” operations.

One solution to avoid data copy routines is to add a level of indirection between data buffers and buffer control blocks (BCBs) by keeping independent addresses for data buffers and BCBs, and providing in the BCB a pointer to the data buffer. However, this solution has the disadvantage of increased bandwidth requirements for BCB updates, and more complex management of data buffers and BCBs.

What is needed is an efficient IP fragmentation solution that minimizes memory requirements for IP fragmentation and IP reassembly in high performance network processor applications.

### SUMMARY OF THE INVENTION

It is, therefore, an object of the present invention to provide data structures, a method, and an associated system for IP fragmentation and reassembly on network processors in order to minimize memory allocation requirements. The invention eliminates the need to copy the entire frame for each multicast instance (i.e., each multicast target), thereby both reducing memory requirements and solving problems due to port performance discrepancies. In addition, the invention provides a means of returning leased buffers to the free queue as they are used (independent of when other instances complete transmission) and uses a counter to determine when all instances are transmitted so that a reference frame can likewise be returned to the free queue.

The present invention eliminates the need to copy the entire frame, adjust byte counts, update the memory link list and update headers for each fragment by utilizing the frame/buffer linking structures within the network processor architecture. In one embodiment, a network processor system comprising a plurality of buffers and buffer control blocks, the buffer control blocks comprising a buffer usage field, the buffer usage field having a value set responsive to a quantity of frame data fragments, associates a buffer control block with each buffer, and frees a first buffer after reading a frame data fragment responsive to the first buffer control block buffer usage field value indicating only one frame data fragment is present in the first buffer.

### BRIEF DESCRIPTION OF THE DRAWINGS

FIG. 1 is a block diagram illustrating a data structure embodiment according to the present invention;

FIG. 2 is a block diagram showing a chip set system environment of one embodiment of the present invention;

FIG. 3 is a block diagram showing in more detail the embedded processor complex and the dataflow chips used in the chip set of FIG. 2;

FIG. 4 is a diagram showing a general message format according to the present invention;

FIG. 5 is a block diagram illustrating data structures according to the invention;

FIG. 6 is a flow diagram showing the IP fragmentation process;

FIG. 7 is a flow diagram showing the IP reassembly process; and

FIG. 8 is an article of manufacture comprising a computer usable medium having a computer readable program according to the present invention embodied in said medium.

### DESCRIPTION OF EMBODIMENTS OF THE INVENTION

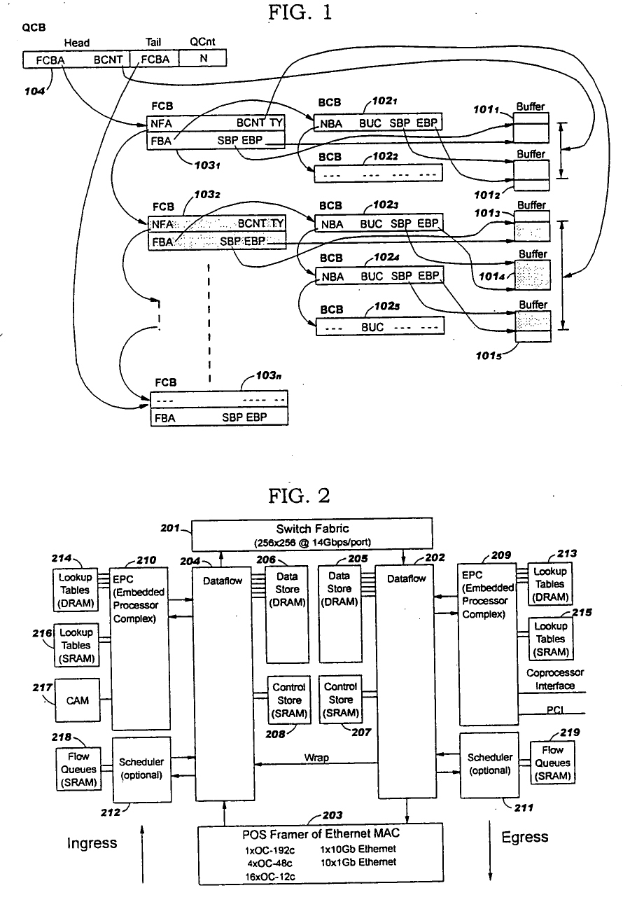

FIG. 1 is a block diagram illustrating data structures of an embodiment of the present invention 100. A frame is stored in a series of buffers 101₁ to 101₅. Each buffer 101 has a corresponding Buffer Control Block (BCB) 102₁ to 102₅, which is used to link the series of buffers into a frame. Each frame has a corresponding Frame Control Block (FCB) 103₁ to 103ₙ, which is used to link a series of frames into a queue. Each queue has a Queue Control Block (QCB) 104, which maintains the address of the first and last FCB 103 in the queue, and a count of the number of frames in the queue.

### Data Structure Definitions

Buffers 101 are used for storage of data. In the present embodiment, each buffer 101 is 64-bytes in size and may store from 1 to 64-bytes of valid data. All valid data within a buffer 101 must be stored as a single contiguous range of bytes. Multiple buffers are chained together via a linked list to store frames larger than 64-bytes. Thus, the present invention may work with conventional computer systems configured to process 64-byte data structures; however, other data structure sizes may be practiced, and the present invention is not limited to 64-byte data structures but may be adapted to accommodate larger buffer sizes as computer system capacities increase in size and complexity.

Initially, all buffers 101 are placed in the free buffer queue. When a frame arrives, buffers are popped from the head of the free buffer queue and used to store the frame data. When the final transmission of a frame is performed, the buffers used to store the frame data are pushed onto the tail of the free buffer queue.

A Buffer Control Block (BCB) 102 forms the linked list for chaining multiple buffers into a frame. It also records which bytes of the corresponding buffer 101 contain valid data. For every buffer 101 there is a corresponding BCB 102. The address of a buffer 101 in Datastore Memory (205 and 206 in FIG. 2) also serves as the address of the corresponding BCB 102 in the BCB Array. A BCB 102 contains the following fields:
The Next Buffer Address (NBA) field is used to store the pointer to the next buffer 101 in a frame. The NBA field in the BCB 102 for the current buffer 101 contains the address of the frame's next buffer 101 (and corresponding BCB 102).
The Starting Byte Position (SBP) field is used to store the offset of the first valid byte of data in the next buffer 101 of a frame. Valid values are from 0 to 63.
The Ending Byte Position (EBP) field is used to store the offset of the last valid byte of data in the next buffer 101 of a frame. Valid values are from 0 to 63.
New and novel to the invention is the provision and application of a Buffer Usage Count (BUC) field to store the number of frames that have data stored in the corresponding buffer. In the present embodiment, a four-bit BUC field supports valid values from 1 to 15. However, the BUC field is not limited to a four-bit size and, if required, the BUC field may be configured in sizes of more or less than four-bits. In contrast to prior art Multicast Instance Counters, the BUC field size is small because of the limited number of data boundaries that could be defined within one data buffer. A data buffer is conventionally fixed in size, usually between 64 and 2 KB, or 256B for 10 Gbps Data Flow FPGA. Thus, in the present embodiment, the four-bit BUC enables the data buffer 101 to be shared by 16 different frames.

Note that the SBP and EBP fields apply to the “next” buffer 101 in the frame and not the buffer 101 corresponding to the current BCB 102. These fields are defined in this way to permit the SBP and EBP information for the next buffer 101 to be fetched concurrently with its address (NBA).

Each of the fields in a BCB 102 is initially loaded by a Dataflow hardware 202, an embodiment of which is illustrated in FIG. 2, during frame reception. Picocode may subsequently modify the fields in the BCB 102 to “edit” the frame prior to transmission. The NBA field may be modified to add or delete buffers in a frame. The SBP and EBP fields may be modified to change the number of valid bytes in a buffer 101. What is new is that the BUC field may be set for buffers that are part of a multicast frame or fragmented frame to request that the buffer 101 be returned to the free buffer queue immediately after its data is transmitted. The present invention thus provides an improvement over prior art multicast and/or fragmentation methods in that buffers can be released when they are actually used (read) for the last time. Prior art methods may require an additional pseudo-transmit of the reference frame to release buffers.

The NBA field of the BCB 102 is also used to form the linked list of buffers in the free buffer queue. The NBA is the only field in the BCB 102 that contains valid information when the corresponding buffer 101 is in the free buffer queue.

A Frame Control Block (FCB) 103 forms the linked list of frames in a queue. It also records the total number of valid bytes in the frame, the buffer address, and SBP/EBP of the first buffer 101 in the frame. An FCB 103 includes the following fields:
The Next Frame Address (NFA) field is used to store the pointer to the next frame in a queue of frames. The NFA field in the FCB 103 for the current frame contains the address of the FCB 103 for the next frame in the queue. This field contains no valid data if the corresponding frame is the last frame in the queue. If the “QCNT” field in the QCB is zero, then no frames exist in the queue. If the “QCNT” field in the QCB is 1, then the “NFA” field in the FCB at the head of the queue is not valid as there is no “next frame” in the queue.
The Byte Count (BCNT) field is used to store a count of the total number of valid bytes in all buffers of the next frame in a queue of frames. Note that the BCNT applies to the “next” frame in the queue, and not the frame associated with the FCB 103 in which the BCNT field is stored. The BCNT field is defined in this way to permit the address (NFA) and length (BCNT) of the next frame in the queue to be fetched concurrently.
The First Buffer Address (FBA) field is used to store the address of the first buffer 101 (and corresponding BCB 102) in a frame.
The SBP and EBP fields are used to store the starting and ending byte positions of valid data in the first buffer 101 of a frame.
Each of the fields in an FCB 103 is initially loaded by the Dataflow hardware 202 (FIG. 2) during frame reception. Picocode may subsequently overlay the BCNT, FBA, SBP, and EBP fields of the FCB 103 prior to frame transmission. The BCNT field may be modified if the length of the frame was changed as a result of editing. The FBA, SBP, and EBP fields may be modified if there is a change in the address or valid data range of the first buffer 101 of the frame.

A free FCB queue is used to maintain a linked list of FCBs that are not currently allocated to a frame. The NFA field of the FCB 103 is used to form the linked list of FCBs in the free FCB queue. The NFA is the only field in the FCB 103 that contains valid information when the corresponding FCB 103 is in the free FCB queue.

A Queue Control Block (QCB) 104 maintains a queue of frames by storing the address of the first and last FCBs in the queue, and a count of the total number of frames in the queue. A QCB 104 contains the following fields:
Head FCBA is used to store the FCB Address (FCBA) of the frame at the head of the queue.
Head BCNT is used to store a count of the total number of valid bytes in the frame at the top of the queue.
Tail FCBA is used to store the FCB Address (FCBA) of the frame at the tail of the queue.
QCNT is used to store a count of the number of frames currently in the queue.

Frames are added to the tail of a queue as follows:
(1) If one or more frames are already in the queue (QCNT greater than or equal to 1), the NFA and BCNT fields in the FCB 103 originally at the tail of the queue are written to chain to the new frame onto the tail of the queue. If no frames were previously in the queue (QCNT equal to 0), the Head FCBA and Head BCNT fields of the QCB 104 are written to establish the new frame as the head of the queue.
(2) The Tail FCBA of the QCB 104 is written to point to the new FCB 103 added to the tail of the queue.
(3) The QCNT of the QCB 104 is incremented by 1 to reflect one additional frame in the queue.

Frames are removed from the head of a queue as follows:
(1) If more than one frame is already in the queue (QCNT greater than 1), the NFA and BCNT fields in the FCB 103 at the head of the queue are read to obtain the FCBA and BCNT for the new frame that will be at the head of the queue. These FCBA and BCNT values are then written to the Head FCBA and Head BCNT of the QCB 104 to establish the new frame at the head of the queue.
(2) The QCNT of the QCB 104 is decremented by 1 to reflect one less frame in the queue.

### Frame Reception

This section describes the use of the data structures from frame reception through dispatch to the network processor.
Step 1: As the first frame data is received, a free buffer address is popped from the head of the free buffer queue and a free FCB 103 is popped from the head of the free FCB queue. Up to 64-bytes of frame data are written to the buffer 101. According to the present invention, the BUC field of the free buffer 101 has an initial value of 1, which is incremented whenever a new boundary is added between data parts within a buffer 101 shared by more than one frame, as will be described in particularity below in the “IP Fragmentation” section. In FIG. 1, the buffers 101 are not shared by more than one frame and, accordingly, do not contain boundaries between separate frames. The BUC value is thus not incremented but remains 1. The FCB 103 is written with the FBA, SBP, and EBP values for the first buffer 101. A working byte count register is set to the number of bytes written to the first buffer 101. f the entire frame fits in the first buffer 101, then go to step 3; otherwise, continue with step 2.

Step 2: If the entire frame does not fit within the first buffer 101, then an additional buffer 101 is popped from the free buffer queue and up to 64-bytes of data are written to the additional buffer 101. The BCB 102 for the previous buffer 101 is written with the NBA, SBP, and EBP values for the current buffer 101. The number of bytes written to the buffer 101 is added to the working byte count register. If the end of the frame is received, then go to step 3; otherwise, repeat step 2. The BUC field value remains 1.

Step 3: The frame is then enqueued onto the tail of an input-queue to await dispatch to the network processor:
(a) If there were previously no frames in the input-queue, then the Head FCBA and Tail FCBA in the input-queue's QCB 104 are written with the address of the new frame's FCB 103. The Head BCNT in the QCB 104 is written with the working byte count register to record the total length of the new frame. The QCNT in the QCB 104 is incremented by 1.
(b) If there were already one or more frames in the input-queue, then the NFA and BCNT fields of the FCB 103 for the prior frame on the tail of the input-queue are written. The NFA field is written with the address of the new frame's FCB 103. The BCNT field is written with the working byte count register to record the length of the new frame. The Tail FCBA of the input-queue's QCB 104 is then written with the address of the new frame's FCB 103. The QCNT in the QCB 104 is incremented by 1.

When the frame reaches the head of the input-queue, it is then de-queued for dispatch to the network processor. The Head FCBA and Head BCNT fields are read from the input-queue's QCB 104. The Head FCBA value is then used to read the contents of the FCB 103 at the head of the queue. The NFA and BCNT values read from the FCB 103 are used to update Head FCBA and Head BCNT fields of the QCB 104. The FBA, SBP, and EBP values read from the FCB 103 are used to locate and read the frame data for dispatch to the network processor. The BCB 102 chain is followed until the frame data required for dispatch is read. The QCNT in the QCB 104 is decremented by 1. As the BUC field values=1, the buffers are immediately released upon reading of the frame.

FIG. 2 depicts the chip set system environment upon which this invention is implemented. Frame data flows from the Switch Fabric 201 to Dataflow chip 202 and then to POS (Packet-Over-SONET) Framer or Ethernet MAC (Media Access Control) 203. From the POS Framer or Ethernet MAC 203, data flows to the Dataflow chip 204 and then to the switch fabric 201. Dataflow chips 202 and 204 are supported by data stores (dynamic random access memory (DRAM)) 205 and 206, respectively, and control stores (static random access memory (SRAM)) 207 and 208, respectively. Dataflow chips 202 and 204 communicate with respective embedded processor complexes (EPCs) 209 and 210, respectively, and optionally with scheduler chips 211 and 212, respectively. The EPCs 209 and 210 are supported by lookup tables 213 and 214, respectively, implemented in DRAM, and lookup tables 215 and 216, respectively, implemented in SRAM. EPC 209 additionally is provided with a coprocessor interface and a Peripheral Component Interconnect (PCI) local bus, while EPC 210 is additionally supported by content addressable memory (CAM) 217. If scheduler chips 211 and 212 are used, they are supported by flow queues 218 and 219, respectively, implemented in SRAM.

Note that all information flowing between the Dataflow 202 (204), EPC (embedded processor complex) 209 (210) and Scheduler 211 (212) is exchanged in a format called “messages.” Information flowing between the Switch Fabric 201, Dataflow 202, and POS framer/Ethernet MAC 203 is in the format of “frames”. Messages are used only for the exchange of “control” information between the Dataflow, EPC and Scheduler chips. Examples of such messages include dispatch, enqueue, interrupt/exception, data read, data write, frame modification, register read and register write. A message may consist of a request or response.

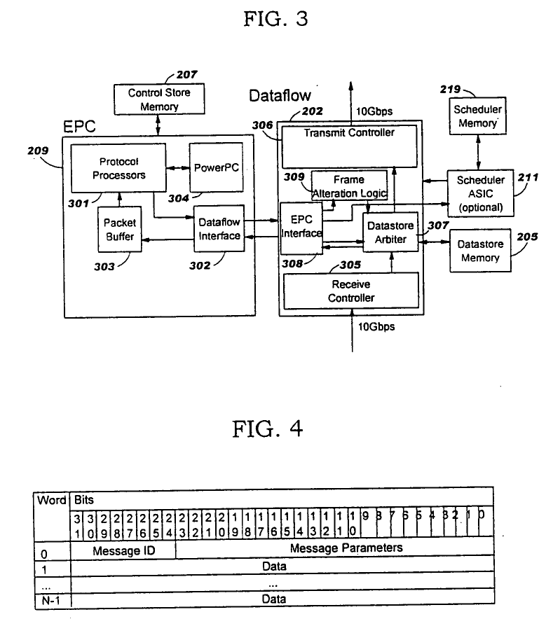

FIG. 3 shows in more detail the Dataflow chip 202 (204), EPC chip 209 (210) and Scheduler chip 211 (212). The EPC chip 209 (210) executes the software responsible for forwarding network traffic. It includes hardware assist functions for performing common operations like table searches, policing, and counting. The Dataflow chip 202 (204) serves as the primary data path for transmitting and receiving traffic via network port and/or switch fabric interfaces. It provides an interface to a large Datastore Memory 205 (206) for buffering of traffic as it flows through the network processor subsystem. It dispatches frame headers to the EPC for processing, and responds to requests from the EPC to modify frame contents and to forward frames to their target destination. An optional Scheduler chip 211 (212) may be added to enhance the Quality of Service (QoS) provided by the network processor subsystem. It permits thousands of network traffic “flows” to be individually scheduled per their assigned QoS level.

The EPC chip 209 (210) includes eight Dyadic Protocol Processor Units (DPPUs) 301 which provide for parallel processing of network traffic. Each DPPU contains two “picocode” engines. Each picocode engine supports two threads. Zero overhead context switching is supported between threads. A picocode instruction store is integrated within the EPC chip. Incoming frames are received from the Dataflow chip 202 (204) via the Dataflow interface 302 and temporarily stored in a packet buffer 303. A dispatch function distributes incoming frames to the Protocol Processors 301. Eight input queue categories permit frames to be targeted to specific threads or distributed across all threads. A completion unit function ensures frame order is maintained at the output of the Protocol Processors 301.

An embedded PowerPC® microprocessor core 304 allows execution of higher level system management software. An 18-bit interface to external DDR SDRAM provides for up to 64 Mbytes of instruction store. A 32-bit PCI interface is provided for attachment to other control functions or for configuring peripheral circuitry, such as MAC or framer components.

A hardware based classification function parses frames as they are dispatched to the Protocol Processors to identify well known Layer-2 and Layer-3 frame formats. The output of classifier is used to precondition the state of a picocode thread before it begins processing of each frame.

A table search engine provides hardware assist for performing table searches. Tables are maintained as Patricia trees with the termination of a search, resulting in the address of a “leaf” entry which picocode uses to store information relevant to a flow. Three table search algorithms are supported: Fixed Match (FM), Longest Prefix Match (LPM), and a unique Software Managed Tree (SMT) algorithm for complex rules based searches. Control Store Memory 206 (207) provides large DRAM tables and fast SRAM tables to support wire speed classification of millions of flows. The SRAM interface may be optionally used for attachment of a Content Addressable Memory (CAM) (217 in FIG. 2) for increased lookup performance.

Picocode may directly edit a frame by reading and writing Datastore Memory 205 (206) attached to the Dataflow chip 202 (204). For higher performance, picocode may also generate frame alteration commands to instruct the Dataflow chip to perform modifications of the frame being processed.

A Counter Manager function assists picocode in maintaining statistical counters. On-chip SRAMs and an optional external SRAM (shared with the Policy Manager) may be used for counting events that occur at frame inter-arrival rates. One of the external Control Store DDR SDRAMs (shared with the table search function) may be used to maintain large numbers of counters for events that occur at a slower rate.

A Policy Manager function assists picocode in policing incoming traffic flows. It maintains thousands of leaky bucket meters with selectable parameters and algorithms. 1K Policing Control Blocks (PolCBs) may be maintained in an on-chip SRAM. An optional external QDR SRAM (shared with the Counter Manager) may be added to increase the number of PolCBs.

The Dataflow chip 202 (204) implements transmit and receive interfaces that may be independently configured to operate in “port” or “switch” interface mode. In port mode, the Dataflow chip exchanges frames for attachment of various network media such as Ethernet MACs or Packet-Over-Sonet (POS) framers. It does this by means of a receive controller 305 and a transmit controller 306. In switch mode, the Dataflow chip exchanges frames in the form of 64-byte cell segments for attachment to cell based switch fabrics. Frames may be addressed up to 64 target network processor subsystems via the switch interface, and up to 64 target ports via the port interface. The interface supports direct attachment of industry POS framers, and may be adapted to industry Ethernet MACs and switch fabric interfaces (such as CSIx) via Field Programmable Gate Array (FPGA) logic.

A large data memory 205 (206) attached to the Dataflow chip 202 (204) via a database arbiter 307 provides a “network buffer” for absorbing traffic bursts when the incoming frame rate exceeds the outgoing frame rate. It also serves as a repository for reassembling IP Fragments, and as a repository for frames awaiting possible retransmission in applications like TCP termination. Multiple DRAM interfaces are supported to provide sustained transmit and receive bandwidth for the port switch interfaces. Additional bandwidth is reserved for direct read/write of Datastore Memory by EPC picocode. The Datastore Memory 205 (206) is managed via linked lists of buffers. Two external SRAMs are used for maintaining linked lists of buffers and frames.

The Dataflow chip 202 (204) implements advanced congestion control algorithms, such as “random early discard” (RED), to prevent overflow of the Datastore Memory 205 (206). The congestion control algorithms operate from input provided by the EPC picocode, EPC policing function, both communicated via the EPC interface 308 and various queue thresholds maintained by the Dataflow and Scheduler chips. A discard probability memory within the Dataflow is maintained by EPC picocode and referenced by the congestion control function to allow implementation of various standard or proprietary discard algorithms.

The Dataflow chip 202 (204) implements a rich set of hardware assist functions for performing frame alterations in frame alteration logic 309 based on commands received from EPC. Frame alteration commands include insertion, deletion, and overlay of data within a frame, as well as frame fragmentation, splitting and joining. Note that the frame alteration logic is not required to implement this invention. The same multicast technique could be used even if the Dataflow chip 202 (204) does not contain the frame alteration logic fiction.

The Dataflow chip 202 (204) implements a technique known as “virtual output queuing,” where separate output queues are maintained for frames destined to different output ports or target destinations. This scheme prevents “head of line blocking” from occurring if a single output port becomes blocked. High and low priority queues are maintained for each output port to permit reserved and non-reserved bandwidth traffic to be queued independently.

The optional Scheduler chip 211 (212) provides for “quality of service” by maintaining flow queues that may be scheduled using various algorithms, such as “guaranteed bandwidth”, “best effort”, “peak bandwidth”, etc. Two external SRAMs are used to maintain thousands of flow queues with hundreds of thousands of frames actively queued. The Scheduler chip 211 (212) supplements the Dataflow chip's congestion control algorithms by permitting frames to be discarded based on per flow queue thresholds.

Note that all information flowing between the Dataflow 202 (204), EPC 209 (210) and Scheduler 211 (212) is exchanged in a format called “messages”. Information flowing between the Switch Fabric 201, Dataflow 202, and POS Framer/Ethernet MAC 203 is in the form of “frames”. Messages are used only for the exchange of “control” information between the Dataflow, EPC and Scheduler chips. Examples of such messages include dispatch, enqueue, interrupt/exception, data read, data write, frame alteration command, register read and register write. A message may consist of a request or response.

The general message format is depicted in FIG. 4. With reference to FIG. 3, the message format contains the following components:

Message-ID: The Message_ID field is an eight-bit encoded value in the first word of the message that uniquely identifies the message type.

Message-Parameters: The Message_Parameters field is a 24-bit value in the first word of a message that may be specified on a per message-type basis for various purposes as follows:
May be used as an extension to the Message_ID field to define other message types.
May be used on a per message-type basis to further qualify the purpose of the message.
May be used to carry “sequence numbers” or other “reference id” information that correlates the data returned in a response.
May be used to specify the message length in the case of variable length messages.
May be used to carry any other data parameter specific to the message.
Data: The remainder of the message may consist of from “0” to “N-1” additional 32-bit “Data” words.

### IP Fragmentation

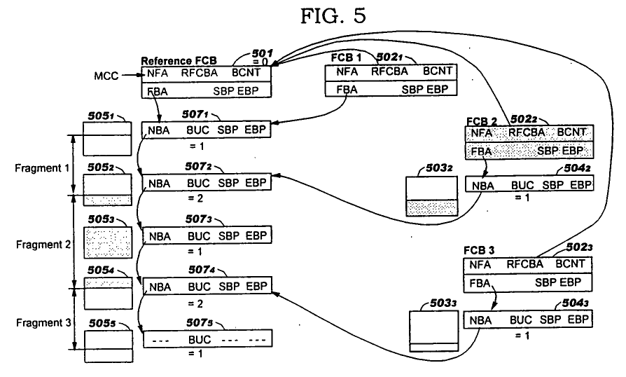

IP fragmentation may be handled as a special case of multicast transmission. FIG. 5 illustrates an example of IP fragmentation where a single frame is received and fragmented into three pieces that are then transmitted as separate frames. For multicast transmissions, each instance (i.e., the data addressed to a particular target) may have a different header, but the body of the frame is identical in each case. IP fragmentation can be handled in a manner analogous to multicast transmission where both the header and the body of each instance are different. The multicast method taught in the co-pending patent application entitled “Apparatus and Method for Efficiently Modifying Network Data Frames” (RPS9220040036), previously incorporated by reference, may be used in the present invention to modify a frame without data copy, actually modifying data on the fly by adding data in an additional buffer and adding a pointer.

The FCB that was assigned when the frame was originally received is retained throughout the life of the frame and is called the “Reference FCB” 501. The network processor obtains additional FCBs (named FCB 1, FCB 2, and FCB 3 in FIG. 5) 502₁, 502₂ and 502₃ and buffers 503₂ and 503₃ associated to their BCBs 504₂ and 504₃, and links the additional FCBs into the original Reference Frame 501 to create each instance of the multicast fragment transmission. Each instance is then queued for transmission.

The FCBs 502 are discarded as each instance is transmitted. The buffers 503 and 505 are discarded when they are read for the last time, as indicated by their BUC field. Before transmission, Buffer Control Blocks 507₁, 507₃, 507₅, 504₂, and 504₃ have their BUC set to 1 because their associated buffers do not include any fragment boundary. Buffer Control Blocks 507₂, and 507₄ have their BUC set to 2 because their associated buffers contain one fragment boundary, so that they must be read two times—one time to get data of the end of a fragment, another time to get data of the beginning of the next fragment. Each time a buffer is read for data transmission, the BUC contained in its associated BCB is decremented, so that when it reaches 1, it can be released immediately.

It should be understood that the invention is not limited to manipulating the BUC field through increasing the field value with the creation of a frame boundary and decreasing the BUC field with each read operation. For example, some embodiments may alternatively decrease a field value with the creation of a frame boundary and increase the BUC field with each read operation, or some other BUC field alteration may occur. Alternatively, the value of the BUC field may be changed through some algorithm. What is important is that the writing of more than frame fragment to a buffer results in a BUC field modification of an initial value in a specified value direction, and that each read operation results in a corresponding BUC field modification in an opposite value direction back toward the initial value, so that the initial value is reached in a number of read operations corresponding to the number of frame fragments within a given buffer. Thus, the number of read operations required to release a buffer is equivalent to the number of frame fragments within the buffer, which is an advantage over prior art methods that require additional read operations to release the buffer. Accordingly, the terms “increment” and “decrement” as applied to the present invention are defined to mean corresponding directional altering of the BUC field, so that each read operation serves to return the BUC field in a step, and the number of steps required to return to the initial value corresponds to the number of frame fragments within the buffer.

The Reference FCB 501 is discarded only after all instances have been transmitted. Because each instance of the frame may be transmitted via a different port, they may complete transmission in a different order than they were enqueued. A Multicast Counter (MCC) is used to determine when all the instances have been transmitted so that the reference frame can be discarded. The MCC is stored in the unused NFA field of the Reference FCB 501, as indicated in the upper left of FIG. 5. It is initialized with the number of instances in the multicast, and then decremented as each multicast instance is transmitted. When the MCC reaches zero, the Reference FCB 501 is discarded by returning it to the free FCB queue.

Reference FCB 501 and the other FCBs 502₁, 502₂ and 502₃ all come from the same free pool of FCBs. When the FCB is being used as the Reference FCB, the NFA/MCC field is used as an MCC. When the FCB is being used as a regular (non Reference FCB), the NFA/MCC field is used as an NFA. The relationship between QCBs and FCBs is illustrated in FIG. 1. FCBs 502₁, 502₂ and 502₃ are all placed into a queue for transmission. The Dataflow includes a QCB for every output queue. Each output queue is typically associated with a port (i.e., network communications link via the POS framer/Ethernet MAC, or another Network Processor via the Switch Fabric). Each of the three multicast instances illustrated in FIG. 5 are queued into an output queue. The NFA field in these FCBs is used to form the linked list of frames in the queue. The Reference FCB 501, however, is not included in any queue. Since the Reference FCB 501 is not included in a queue of frames, the NFA field is not required to form a linked list. Instead, these bits of the NFA are used for storage of the MCC. The address of the Reference FCB is stored in the RFCBA field in the FCB.

The EPC chip 202 performs the following actions to enqueue each instance of the multicast frame:
(1) An FCB 502 is obtained from the free FCB queue and is assigned to the instance.
(2) One or more buffers 503 may be obtained by de-queuing corresponding BCBs 504 from the free buffer queue to contain any unique header data for the instance. However, this assignment is not mandatory. For example, no buffer 503 or BCB 504 is assigned to FCB 1 (502₁).
(3) Any unique data for the instance is written to the buffers 503 obtained above. It is normal for each fragment of the frame to be transmitted with different header data (i.e., different sequence numbers, fragments lengths, etc.).
(4) The BCBs 504 associated with the unique instance buffers are written to create a linked list that attaches them to the buffers of the original “reference frame”. The unique instance buffers are linked to buffer in the reference frame that contains the first byte of the fragment to be transmitted. The SBP and EBP values are written in each BCB 504 to reflect the valid bytes in the next buffer.

This permits the BCB 504 for the last unique buffer for the instance to specify a starting byte offset in the first linked buffer from the reference frame that is the first byte of the fragment to be transmitted. If an instance can use the same, or part of the same, header than the one already in the reference frame, then no unique instance buffer is needed and the description of the first data of the instance is found in the FCB, as shown in 502₁. The BUC field is set to indicate the number of instances that share the same buffer to store data, so that the buffer can be released on-the-fly when the last data read operation has been completed.
(5) The network processor then issues an enqueue operation to release the instance to the Dataflow 202 for transmission. The following information is provided to the Dataflow 202 as part of the enqueue operation:
   Target Queue Number specifies which output queue the multicast instance is to be enqueued into.
   FCBA specifies the Frame Control Block Address (FCBA) assigned to the multicast instance by the network processor.
   BCNT specifies the total length of the fragment. It may be different for each multicast instance.
   FBA specifies the address of the first buffer 101 in the multicast instance. The first buffer 101 is always unique to the multicast instance.
   SBP/EBP specifies the starting and ending byte position of valid data in the first buffer 101.
   RFCBA is a Reference FCB Address that specifies the address of
      the FCB associated to the original frame.

Multicast Action. When enqueuing a multicast instance, the network processor specifies whether the current enqueue is the first, middle, or last instance of the multicast transmission.
01 Multicast First. The first instance enqueued is identified as “multicast first”.
10 Multicast Middle. If the frame fragmentation consists of more than two instances, then any intermediate instances are identified as “multicast middle”.
11 Multicast Last. The last instance enqueued is identified as “multicast last”.

The following describes the Dataflow chip's actions from reception of the enqueue operation through transmission of the multicast fragment instance via the target output port:
(1) The Dataflow chip 202 uses the address RFCBA of the Reference FCB 501 to access the Reference FCB 501 for storage of an MCC value. The MCC value is stored in the NFA field of the Reference FCB 501 (the NFA field of the Reference FCB 501 is unused since the Reference Frame is not directly in any queue). The value of the MCC 506 is updated as follows on enqueue:
   If Multicast Action is 01 (Multicast First), then the MCC 506 is set to 2.
   If Multicast Action is 10 (Multicast Middle), then the MCC 506 is incremented by 1.
   If Multicast Action is 11 (Multicast Last), then the MCC 506 is not modified.
(2) The Dataflow chip 202 writes the FBA, SBP, and EBP values to the FCB 502 specified by the parameters provided in the enqueue command.
(3) The Dataflow chip 202 enqueues the frame into the requested output queue specified by the Target Queue Number value provided in the enqueue. It does this as follows:
   (a) If there were previously no frames in the output queue, then the Head FCBA and Tail FCBA in the output queue QCB 104 (FIG. 1) are written with the FCBA value provided in the enqueue. The Head BCNT in the QCB 104 is written with the BCNT value provided in the enqueue. The QCNT in the QCB 104 is incremented by 1.
   (b) If there were already one or more frames in the output queue, then the NFA and BCNT fields of the FCB 502 for the frame previously on the tail of the output queue are written. The NFA and BCNT fields are written with the FCBA and BCNT values provided in the enqueue. The Tail FCBA field of the output queue QCB 104 (FIG. 1) is then written with the FCBA value provided in the enqueue. The QCNT in the QCB 104 is incremented by 1.
(4) When the fragment reaches the head of the output queue, it is then de-queued for transmission via the output port. The Head FCBA and Head BCNT fields are read from the output queue's QCB 104. The Head BCNT value is loaded into a working byte count register for use during transmission of the fragment. The Head FCBA value is used to read the contents of the FCB 502 at the head of the queue. The NFA and BCNT values read from the FCB 502 are used to update Head FCBA and Head BCNT fields of the QCB 104 (FIG. 1). The FBA, SBP and EBP fields read from the FCB 502 are loaded into working registers for use during transmission of the data from the first buffer 504. The FCB 502 is then discarded as its address is pushed onto the tail of the free FCB queue. The QCNT in the QCB 104 is decremented by 1.
(5) The FBA, SBP, and EBP values read from the FCB 103 are used to locate and read the contents of the first buffer 101 of the frame. The address of the Reference FCB 501 is extracted from the FCB and stored in a working register for use after the frame transmission is complete. The frame data from the buffer 101 (if any is present) is then placed into an output FIFO (first in, first out buffer) to be transmitted via the output port. The number of bytes placed into the output FIFO is the lesser of the working byte count register and the number of valid bytes in the buffer 101 as indicated by the SBP and EBP values. The working byte count register is then decremented by the number of bytes of data placed into the output FIFO. If the value in the working byte count register is still greater than zero, then the NBA, SBP, and EBP values are read from the BCB 102 corresponding to the first buffer 101 and are loaded into working registers for use in transmission of the next buffer 101. The first buffer 101 is then discarded if its BUC reaches 1 after decrementation, as its buffer address is pushed onto the tail of the free buffer queue.
(6) The NBA, SBP, and EBP values read from the BCB 102 are used to locate and read the contents of the next buffer 101 of the frame. The frame data from the buffer 101 is then placed into the output FIFO to be transmitted via the output port. The number of bytes placed into the output FIFO is the lesser of the working byte count register and the number of valid bytes in the buffer 101 as indicated by the SBP and EBP values. The working byte count register is then decremented by the number of bytes of data placed into the output FIFO. If the value in the working byte count register is still greater than zero, then the NBA, SBP and EBP values are read from the BCB 102 for the current buffer 101 and are loaded into working registers for use in transmission of the next buffer 101. As described above, the BUC field for the current buffer 101 is decremented each time the buffer 101 is read, and once it reaches a value of 1, it is discarded by pushing its buffer address onto the tail of the free buffer queue. This Step (6) is then repeated until the working byte count register has been decremented to zero.
(7) After completion of the frame transmission, the Reference FCB address previously stored in a working register is used to read the MCC field in reference FCB 501 stored in the NFA field of the Reference FCB 501. One of the following two actions is then performed:
   (a) If the MCC value is greater than one, then it is decremented by one and written back to the NFA/MCC field of the Reference FCB 501. Transmission of this multicast instance is then complete. However, the reference FCB may not be discarded because the other multicast instances have not completed transmission.
   (b) If the MCC value is equal to one, then the Reference FCB 501 is released by pushing it to the tail of the FCB free queue. Transmission of all instances of the multicast frame is then complete.

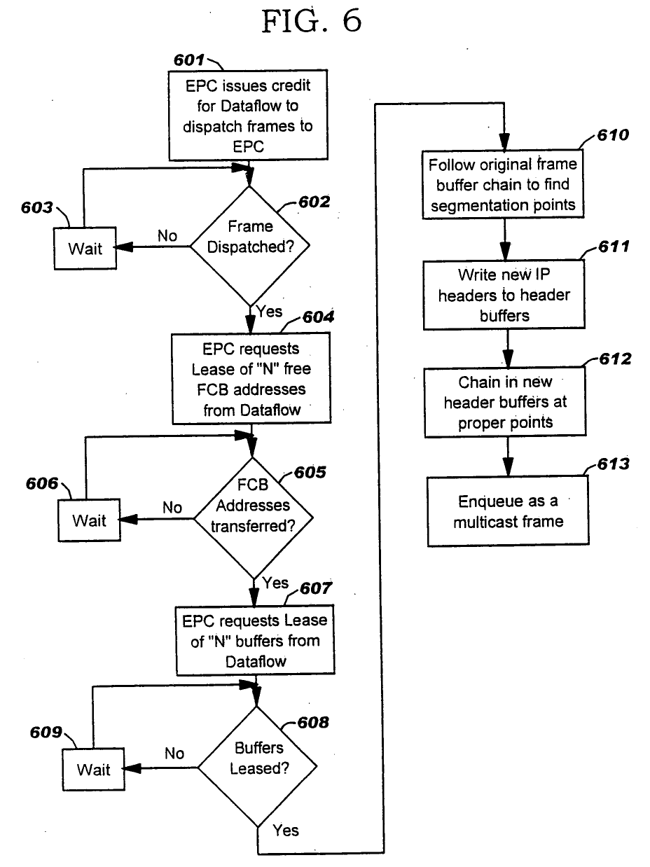

FIG. 6 depicts a flowchart showing how IP fragmentation is accomplished with the invention. The process begins in fiction block 601 by the EPC 209 issuing credits for the Dataflow chip 202 to dispatch frames to the EPC 209. A determination is made in decision block 602 as to whether a frame has been dispatched. If not, the process waits in fiction block 603. When a frame has been dispatched, the EPC 209 requests the lease of “N” free FCB addresses from the Dataflow chip 202 in fiction block 604. A determination is made in decision block 605 as to whether the requested FCB addresses have been transferred. If not, the process waits in function block 606. When the FCB addresses have been transferred, the EPC 209 requests the lease of “N” buffers from the Dataflow chip 202 in function block 607. A determination is then made in decision block 608 as to whether the buffers have been leased. If not, the process waits in function block 609. When the buffers have been leased, the process follows the original frame buffer chain to find segmentation points in fiction block 610. After the segmentation points have been found, the process writes new IP headers to header buffers in fiction block 611. In function block 612, the process then chains in new header buffers at the proper points. Finally, the process then enqueues the result as a multicast frame in function block 613.

### IP Reassembly

IP reassembly is the reverse of IP fragmentation. Multiple frame fragments are received and must be reassembled into a single frame for transmission. The data structures described previously support this process:
(1) The network processor stores the FCB value of each frame fragment as it arrives.
(2) When all fragments of the frame have arrived, the network processor determines the proper order of each of the frame fragments.
(3) The BCB linked lists of each of the frame fragments are then linked by the network processor into a single chain of buffers that make up the reassembled frame.
(4) The network processor then enqueues the reassembled frame to the Dataflow for transmission. It specifies a BCNT value that reflects the total length of the reassembled frame. The FCB value received with the first frame fragment is used as the FCB value for the reassembled frame.
(5) The network processor then returns the unused FCB values for the other fragments to the free FCB queue.

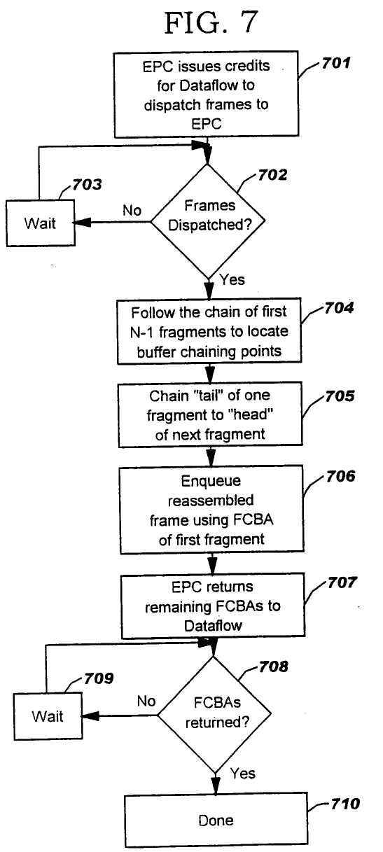

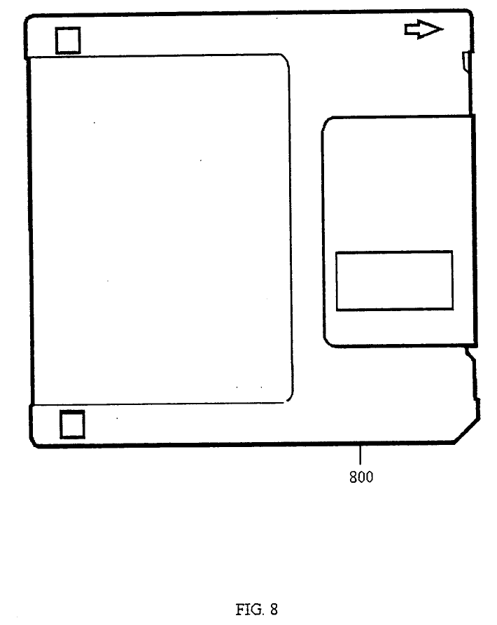

FIG. 7 depicts a flowchart showing how IP reassembly is accomplished with the invention. The process begins in function block 701 by the EPC 210 issuing credits for the Dataflow chip 204 to dispatch frames to the EPC 210. A determination is made in decision block 702 as to whether a frame has been dispatched. If not, the process waits in fiction block 703. When a frame has been dispatched, the process then follows the chain of the first N-1 fragments to locate the buffer chaining points in function block 704. In function block 705, the process then chains the tail of one fragment to the head of the next fragment. In fiction block 706, the reassembled frame is then enqueued using the FCBA of the first fragment. The FCBAs of the other fragments are then returned to the EPC 209 in function block 707. In decision block 708, a determination is made as to whether the FCBAs have all been returned. If not, the process waits in function block 709. When the FCBAs have all been returned, the process ends in function block 710.

The inventions described above may be tangibly embodied in a computer program residing on a computer-readable medium or carrier 800. The medium 800 may comprise one or more of a fixed and/or removable data storage device, such as a floppy disk or a CD-ROM, or it may consist of some other type of data storage or data communications device. The computer program may be loaded into a memory device in communication with a network processor for execution. The computer program comprises instructions which, when read and executed by the processor, causes the processor to perform the steps necessary to execute the steps or elements of the present invention.

While embodiments of the invention have been described herein, variations in the design may be made, and such variations may be apparent to those skilled in the art of computer architecture, systems and methods, as well as to those skilled in other arts. The present invention is by no means limited to the specific programming language and exemplary programming commands illustrated above, and other software and hardware implementations will be readily apparent to one skilled in the art. The scope of the invention, therefore, is only to be limited by the following claims.

What is claimed is:

1. A method of sharing data buffers on a network processor comprising the steps of:
providing a plurality of buffers;
associating a buffer control block with each buffer;
providing a buffer usage field in each of the buffer control blocks, the buffer usage field having a value set responsive to a quantity of frame data fragments;
freeing a first buffer after reading a frame data fragment responsive to the first buffer control block buffer usage field value indicating only one frame data fragment is present in the first buffer.

2. The method for sharing data buffers as recited in claim 1, further comprising the steps of:
providing a buffer usage field initial value;
incrementing the first buffer control block buffer usage field value responsive to writing second frame data to the first buffer if the buffer already contains first frame data; and
decrementing the first buffer control block buffer usage field responsive to reading either the first frame data or the second frame data from the first buffer;
wherein the step of freeing the first buffer is performed when the first buffer usage field is the initial value.

3. The method for sharing data buffers as recited in claim 2, further comprising the steps of:
providing a plurality of frame control blocks;
receiving a frame and associating the frame with an original frame control block of the frame control blocks;
fragmenting the frame into a plurality of frame fragments;
storing the frame fragments in the buffers and associating the buffers with fragment frame control blocks and linking the fragment frame control blocks with the original frame control block, the fragment buffers chained together by a linked list, wherein a buffer may contain more than one fragment; and
freeing the original frame control block when all fragments assigned to the original frame control block have been read.

4. The method for sharing data buffers as recited in claim 3, further comprising the steps of:
providing a Multicast Count field in the original frame control block;
incrementing the Multicast Count field for each of a plurality of frame fragments from an original frame; and
decrementing the Multicast Count field responsive to reading each frame fragment from the first buffer;
wherein the step of freeing the original frame control block is responsive to the frame control block Multicast Count field returning to an initial value.

5. The method for sharing data buffers as recited in claim 4, further comprising the steps of:
providing the plurality of buffers in a free buffer queue;
providing the plurality of frame control blocks in a free frame control block queue;
receiving frames into a frame queue to await dispatch to a network processor;
associating a queue control block with the frame queue;
associating the original frame control block from the free frame control block queue with a frame in the frame queue; and
assigning additional buffers from the free buffer queue and additional frame control blocks from the free control block queue for each frame fragment of the plurality of frames and linking the additional frame control blocks with the original frame control block;
wherein the step of freeing the fragment buffer comprises returning the additional buffer assigned to any of the fragments to the free buffer queue when the buffer is read a number of times equal to a quantity of fragments contained in the buffer; and
wherein the step of freeing original frame control block comprises returning the original frame control block to the free control block queue when all fragments assigned to the original frame control block have been read.

6. The method for sharing data buffers as recited in claim 2 wherein the buffer control block associated with each buffer forms a linked list for chaining buffers into a frame and contains a plurality of fields, including separate fields to:
store a pointer to a next buffer in the frame;
store a starting byte position of valid data in a next buffer of a frame;
store an ending byte position of valid data in a next buffer of a frame; and
store a number of frame fragments stored in a corresponding buffer.

7. The method for sharing data buffers as recited in claim 3, wherein the frame control block associated with each frame forms a linked list for chaining frames into a queue and contains a plurality of fields, including separate fields to:
store a pointer to a next frame in the queue, or a number of frame instances using data of a reference frame;
store a count of a total number of bytes of a next frame in the queue;
store an address of a first buffer in a frame;
store a starting byte position of valid data in the first buffer; and
store an ending byte position of valid data in the first buffer.

8. The method for sharing data buffers as recited in claim 3, wherein the buffer control block buffer usage field is incremented once for every fragment boundary.

9. A network processor system comprising:
a plurality of buffers;
a plurality of buffer control blocks, each of the buffer control blocks associated with one of the plurality buffers; and
a buffer usage field in each of the buffer control blocks, the buffer usage field having a value set responsive to a quantity of frame data fragments;
wherein the system is configured to free a buffer after reading a frame data fragment responsive to the buffer control block buffer usage field value indicating only one frame data fragment is present in the buffer.

10. The system of claim 9, further comprising a buffer usage field initial value;
wherein the system is configured to increment the first buffer control block buffer usage field value responsive to writing a second frame data to the buffer if the buffer already contains a first frame data; and
to decrement the first buffer control block buffer usage field responsive to reading either the first frame data or the second frame data from the first buffer;
wherein the first buffer is freed when the first buffer usage field is the initial value.

11. The system of claim 10, further comprising a plurality of frame control blocks;
wherein the system is configured to receive a frame and associate the frame with an original frame control block of the plurality of frame control blocks;
fragment the frame into a plurality of frame fragments;
store the frame fragments in the buffers and associate the buffers with fragment frame control blocks and link the fragment frame control blocks with the original frame control block, the fragment buffers chained together by a linked list, wherein a buffer may contain more than one fragment; and
free the original frame control block when all fragments assigned to the original frame control block have been read.

12. The system of claim 11, further comprising a Multicast Count field in the original frame control block;
wherein the system is configured to increment the Multicast Count field for each of a plurality of frame fragments from an original frame; and
decrement the Multicast Count field responsive to reading each frame fragment from the first buffer;
wherein the original frame control block is freed responsive to the frame control block Multicast Count field returning to an initial value.

13. The system of claim 12, further comprising:
a free buffer queue containing the plurality of buffers; and
a free frame control block queue containing the plurality of frame control blocks;
wherein the system is configured to receive frames into a frame queue to await dispatch to a network processor;
associate a queue control block with the frame queue;
associate the original frame control block from the free frame control block queue with a frame in the frame queue;
assign additional buffers from the free buffer queue and additional frame control blocks from the free control block queue for each frame fragment of the plurality of frames and link the additional frame control blocks with the original frame control block;
free the fragment buffer by returning the additional buffer assigned to any of the fragments to the free buffer queue when the buffer is read a number of times equal to a quantity of fragments contained in the buffer; and
free the original frame control block by returning the original frame control block to the free control block queue when all fragments assigned to the original frame control block have been read.

14. The system of claim 10 wherein the buffer control block associated with each buffer forms a linked list for chaining buffers into a frame and contains a plurality of fields, including separate fields to:
store a pointer to a next buffer in the frame;
store a starting byte position of valid data in a next buffer of a frame;
store an ending byte position of valid data in a next buffer of a frame; and
store a number of frame fragments stored in a corresponding buffer.

15. The system of claim 11 wherein the frame control block associated with each frame forms a linked list for chaining frames into a queue and contains a plurality of fields, including separate fields to:
store a pointer to a next frame in the queue, or a number of frame instances using data of a reference frame;
store a count of a total number of bytes of a next frame in the queue;
store an address of a first buffer in a frame;
store a starting byte position of valid data in the first buffer; and
store an ending byte position of valid data in the first buffer.

16. The system of claim 11, wherein the buffer control block buffer usage field is incremented once for every fragment boundary.

17. An article of manufacture comprising a computer usable medium having a computer readable program embodied in said medium, wherein the computer readable program when executed on a network processor system comprising a plurality of buffers and buffer control blocks, the buffer control blocks comprising a buffer usage field, the buffer usage field having a value set responsive to a quantity of frame data fragments, causes the network processor to:
associate a buffer control block with each buffer; and
free a first buffer after reading a frame data fragment responsive to the first buffer control block buffer usage field value indicating only one frame data fragment is present in the first buffer.

18. The article of manufacture of claim 17, wherein the network processor system further comprises a buffer usage field initial value, and wherein the computer readable program causes the network processor to:
increment the first buffer control block buffer usage field value responsive to writing second frame data to the first buffer if the buffer already contains first frame data;
decrement the first buffer control block buffer usage field responsive to reading either the first frame data or the second frame data from the first buffer; and
free the first buffer when the first buffer usage field is the initial value.

19. The article of manufacture of claim 18, wherein the network processor system further comprises a plurality of frame control blocks, and wherein the computer readable program causes the network processor to:
receive a frame and associate the frame with an original frame control block of the frame control blocks;
fragment the frame into a plurality of frame fragments;
store the frame fragments in the buffers and associate the buffers with fragment frame control blocks and link the fragment frame control blocks with the original frame control block, the fragment buffers chained together by a linked list, wherein a buffer may contain more than one fragment; and
free the original frame control block when all fragments assigned to the original frame control block have been read.

20. The article of manufacture of claim 19, wherein the network processor system further comprises a Multicast Count field in the original frame control block, and wherein the computer readable program causes the network processor to:
increment the Multicast Count field for each of a plurality of frame fragments from an original frame;
decrement the Multicast Count field responsive to reading each frame fragment from the first buffer; and
free the original frame control block responsive to the frame control block Multicast Count field returning to an initial value.
